(19) United States
(12) Patent Application Publication
(10) Pub. No.: US 2018/0323531 A1
(43) Pub. Date: Nov. 8, 2018

(54) FOLDABLE POWER STRIP STORAGE TRAY

(71) Applicant: PTAH INC., Seoul (KR)

(72) Inventor: JE WUK JUNG, Seoul (KR)

(73) Assignee: PTAH INC., Seoul (KR)

(21) Appl. No.: 15/770,711

(22) PCT Filed: Oct. 25, 2016
(86) PCT No.: PCT/KR2016/012028

§ 371 Date: Apr. 24, 2018

(30) Foreign Application Priority Data
Oct. 26, 2015 (KR) 20-2015-0006923

(51) Int. Cl. H01R 13/46; B65D 1/22; B65D 6/18; H01R 13/66

(52) U.S. Cl. CPC H01R 13/46; H01R 13/66; B65D 11/1846; B65D 1/225

(57) ABSTRACT

A foldable power strip storage tray is provided. The foldable power strip storage tray includes: a main body provided with an inner space to accommodate a power strip; a fixing portion having one side opened and having an upper end hanging on one side of a desk, and configured to support a load of the main body and simultaneously to fix the main body to a lower side of the desk when a lower end of the fixing portion is received in the main body; and a holding portion disposed on an upper side of the desk, and configured to prevent the fixing portion from sliding from one side of the desk or from being released by a movement when an area of a predetermined length of an upper end of the fixing portion is drawn in the holding portion. Accordingly, since the power strip is accommodated in the inner space of the power strip storage tray attached to the lower side of the desk, problems that the power strip or electric cables are stepped on by a foot and thus are damaged, power supply to electric devices is suddenly stopped, or a moving line of a cleaner is hindered when the floor is cleaned can be solved. In addition, when the power strip is not accommodated in the inner space of the power strip storage tray, the tray is unfolded and then is folded, and is stored with its volume being minimized, and thus there is a space saving effect. In addition, the charging cable connected with the terminal can be prevented from being released by a movement, and there is an effect of holding the terminal on the upper side of the desk.

### TECHNICAL FIELD

The present disclosure relates to a foldable power strip storage tray, and more particularly, to a power strip storage tray which can accommodate a power strip in an inner space of a storage tray provided to be spaced from a floor, and can have its volume minimized by being folded when not in use.

### BACKGROUND ART

In general, a power strip refers to an apparatus that extends a socket to a place requiring power or increases the number of sockets to efficiently supply power to home appliances, and is widely used in households, offices, or factories as the demand for home appliances increases in recent years.

Electric cables of electric devices connected with such a power strip may be tangled and may be difficult to identify, and also, since the power strip is mostly placed on a floor, there may be inconvenience that the power strip should be moved when the floor is cleaned. In addition, there may be inconvenience that the power strip or electric cables are stepped on by a foot and thus are damaged, or power supply to electric devices is suddenly stopped.

As a solution to these problems, Korean Patent Registration No. 10-1323013 (registered on Oct. 22, 2013) discloses a power strip device that has a case formed in a cuboid shape, having a front portion opened, and placed on a desk, and can prevent electric cables from being tangled when a socket unit having a plurality of plugs inserted thereinto is placed in an inner space. However, the related-art technology may have inconvenience in that the case formed in the cuboid shape and having the socket unit placed in the inner space thereof occupies a space on an upper side of a desk where a user performs a task, and, when the case is stored separately, it occupies more storage space since it is stored in the form of the cuboid shape.

### DISCLOSURE

### Technical Problem

The present disclosure has been developed in order to address the above-discussed deficiencies of the prior art, and an object of the present disclosure is to provide a foldable power strip storage tray which can accommodate a power strip in an inner space provided to be attached to a lower side of a desk spaced from a floor, and can prevent problems that the power strip or electric cables are stepped on by a foot and thus are damaged, power supply to electric devices is suddenly stopped, or a moving line of a cleaner is hindered when the floor is cleaned.

In addition, another object of the present disclosure is to provide a foldable power strip storage tray which can have its volume minimized by being folded when being stored separately.

In addition, still another object of the present disclosure is to provide a foldable power strip storage tray which can hold a terminal which has a charging cable connected to a power strip and is being charged on an upper side of a desk.

### Technical Solution

According to an embodiment of the present disclosure to achieve the above-described objects, a foldable power strip storage tray includes: a main body provided with an inner space to accommodate a power strip; a fixing portion having one side opened and having an upper end hanging on one side of a desk, and configured to support a load of the main body and simultaneously to fix the main body to a lower side of the desk when a lower end of the fixing portion is received in the main body; and a holding portion disposed on an upper side of the desk, and configured to prevent the fixing portion from sliding from one side of the desk or from being released by a movement when an area of a predetermined length of an upper end of the fixing portion is drawn in the holding portion.

In addition, the main body may include: a front plate having a hinge disposed at one side thereof to be opened and closed forward and backward to allow the power strip to be accommodated in the inner space or to be drawn out therefrom, the front plate being provided with a plurality of wings protruding from both sides thereof extending in a perpendicular direction to the one side; a lower plate having one side coupled to the hinge of the front plate and having a hinge disposed at the other side to allow the power strip to be accommodated in the inner space after the front plate is opened; a rear plate having a fixing receiving recess formed in a direction to allow a lower end of the fixing portion to be drawn in therethrough, and to allow the fixing portion to support the load of the main body, the rear plate having one side coupled to the hinge of the lower plate and having a hinge disposed at the other side; an upper plate having one side coupled to the hinge disposed at the other side of the rear plate; and a left plate and a right plate having a plurality of wing receiving recesses formed on outer surfaces thereof to correspond to shape of the plurality of wings to allow the front plate to be opened and closed based on the wings, inner surfaces of the left plate and the right plate being coupled to both sides of the lower plate, both sides of the rear plate, and both sides of the upper plate.

In addition, both ends of one side of the rear plate and both ends of the other side of the lower plate, and both ends of the other side of the rear plate and both ends of one side of the upper plate may be formed to have recessed corners to allow an end of one or more charging cables connected to the power strip to be accommodated in the inner space, and, when the main body is assembled, a plurality of cable receiving recesses may be formed to receive the plurality of charging cables.

In addition, the main body may include protrusions formed on both sides of the lower plate, both sides of the rear plate, and both sides of the upper plate to allow the left plate and the right plate to be attached to or detached from the other portions of the main body, and protrusion receiving recesses may be formed on the inner surfaces of the left plate and the right plates to receive the protrusions.

In addition, when the left plate and the right plate of the main body are detached based on the protrusions and then the other portions of the main body is unfolded, the main body portion may be folded with reference to the hinge disposed on the lower plate and then may be folded in such a manner that the lower plate and the rear plate are brought into contact with each other and the upper plate and the front plate are brought into contact with each other.

In addition, after the main body portion is folded, inner surfaces of the wings formed on the front plate and the protrusions formed on the upper plate may be brought into contact with each other, and the upper plate may be fitted into the front plate, such that the main body is prevented from being released by a movement.

In addition, the fixing portion may include: a fixing frame having one side opened to allow an upper side of the main body and one side of the desk to be drawn in therethrough; a pressing member configured to press the upper side of the main body to stably fix the main body to the lower side of the desk; a shaft member formed on a lower side of the pressing member to allow the pressing member to press the main body or to be spaced from the main body, and configured to move the pressing member upwardly and downwardly by being rotated through the lower end of the fixing frame in a perpendicular direction to a floor; and a rotation adjustment member formed on a lower side of the shaft member to move the pressing member upwardly and downwardly by a predetermined height in the perpendicular direction to the floor through the shaft member.

In addition, the holding portion may include one or more receiving recesses to hold a terminal on one side after the upper end of the fixing portion is drawn in, the holding portion being configured to maintain the terminal in a held position even when a charging cable connected to the terminal moves, and one receiving recess may be configured to receive the upper end of the fixing portion, and the other receiving recess may be configured to receive the charging cable.

In addition, the receiving recess of the one or more receiving recesses of the holding portion that has the fixing portion received therein may have a shape corresponding to that of the upper end of the fixing portion, such that the holding portion is prevented from being released by a movement after the upper end of the fixing portion is drawn therein.

### Advantageous Effects

Accordingly, since the power strip is accommodated in the inner space of the power strip storage tray attached to the lower side of the desk, problems that the power strip or electric cables are stepped on by a foot and thus are damaged, power supply to electric devices is suddenly stopped, or a moving line of a cleaner is hindered when the floor is cleaned can be solved.

In addition, when the power strip is not accommodated in the inner space of the power strip storage tray, the tray is unfolded and then is folded, and is stored with its volume being minimized, and thus there is a space saving effect.

In addition, the charging cable connected with the terminal can be prevented from being released by a movement, and there is an effect of holding the terminal on the upper side of the desk.

### DESCRIPTION OF DRAWINGS

FIG. 1 is a perspective view illustrating a foldable power strip storage tray according to an embodiment of the present disclosure;

FIG. 2 is a view showing a power strip being accommodated in the foldable power strip storage tray according to an embodiment of the present disclosure;

FIG. 3 is a view illustrating the foldable power strip storage tray when it is in use according to an embodiment of the present disclosure;

FIG. 4 is a view illustrating a main body in an unfolded position according to an embodiment of the present disclosure;

FIG. 5 is a view illustrating the main body in a folded position according to an embodiment of the present disclosure;

FIG. 6 is a view illustrating a fixing portion and a holding portion which are coupled to each other according to an embodiment of the present disclosure;

FIG. 7 is a view illustrating a state before the main body is attached to a lower side of a desk according to an embodiment of the present disclosure;

FIG. 8 is a view illustrating a state in which the main body is attached to the lower side of the desk according to an embodiment of the present disclosure;

FIG. 9 is a view illustrating a using example of the holding portion according to an embodiment of the present disclosure;

FIG. 10 is a view illustrating a holding portion according to another embodiment of the present disclosure;

FIG. 11 is a view illustrating a holding portion according to still another embodiment of the present disclosure; and

FIG. 12 is a view illustrating a holding portion according to yet another embodiment of the present disclosure.

### BEST MODE

Hereinafter, embodiments of the present disclosure will be described in detail with reference to the accompanying drawings. Embodiments introduced hereinafter are provided by way of an example such that the idea of the present disclosure is fully conveyed to a person skilled in the art. The present disclosure is not limited to embodiments described below and may be specified in other forms. Portions which have nothing to do with the description are omitted from the drawings to more clearly describe the present disclosure, and in the drawings of the present disclosure, widths, lengths, thicknesses, etc. of elements may be exaggerated for easy understanding of technical features. Throughout the description, the same reference numerals indicate the same elements.

According to an embodiment of the present disclosure, there is provided a foldable power strip storage tray which can accommodate a power strip in an inner space provided to be attached to a lower side of a desk spaced from a floor, and can prevent problems that the power strip or electric cables are stepped on by a foot and thus are damaged, power supply to electric devices is suddenly stopped, or a moving line of a cleaner is hindered when the floor is cleaned.

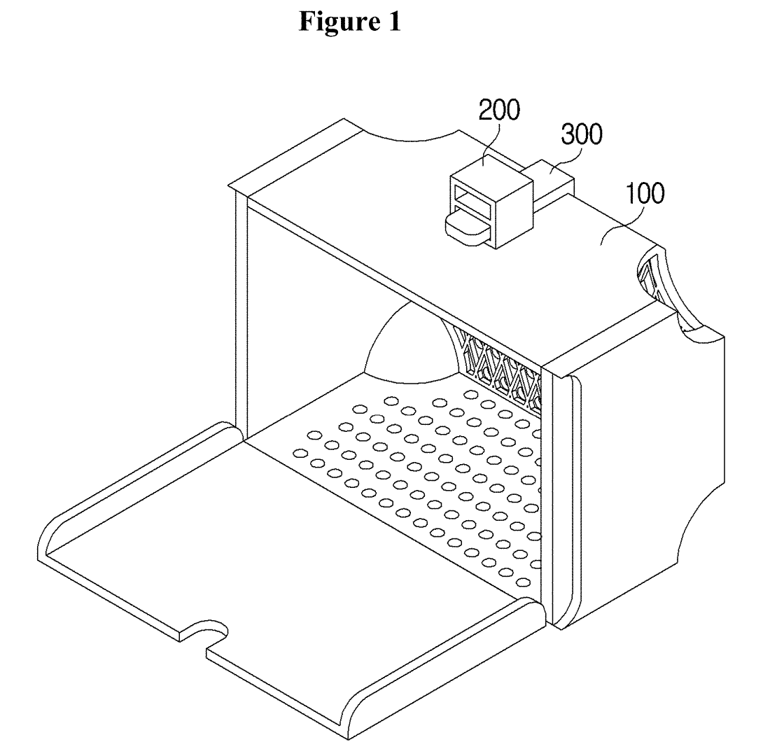

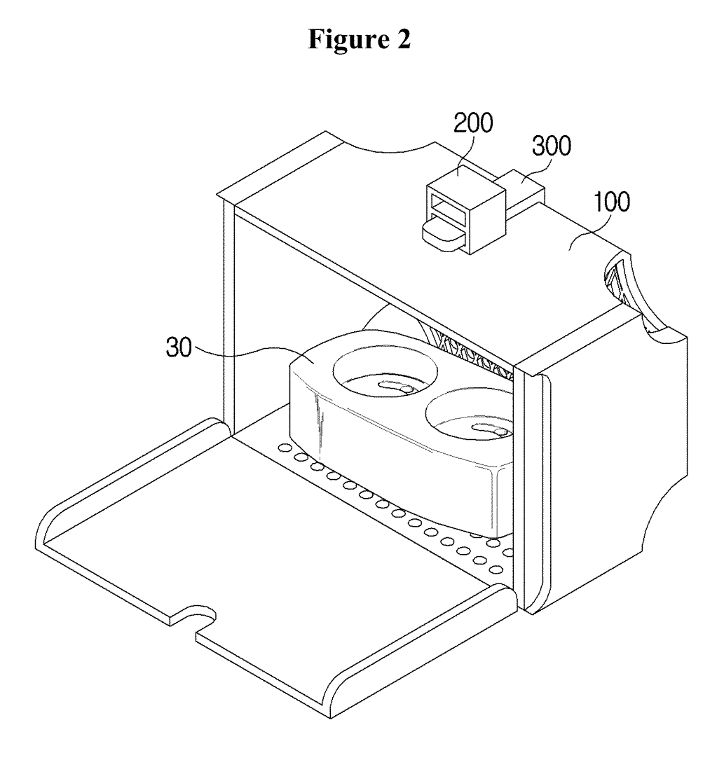

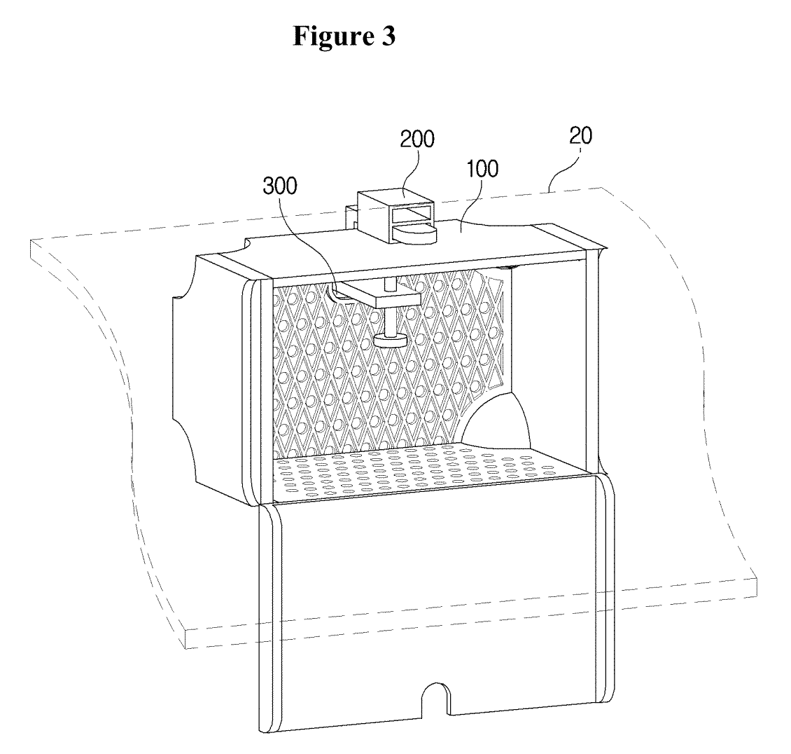

FIG. 1 is a perspective view illustrating a foldable power strip storage tray according to an embodiment of the present disclosure, FIG. 2 is a view illustrating a power strip being accommodated in the foldable power strip storage tray according to an embodiment of the present disclosure, and FIG. 3 is a view illustrating the foldable power strip storage tray when it is in use according to an embodiment of the present disclosure.

As shown in FIGS. 1 and 3, the foldable power strip storage tray according to an embodiment of the present disclosure includes a main body 100, a holding portion 200, and a fixing portion 300.

The main body 100 may be attached to a lower side of a desk 20, and may be configured in an unfolded position when a power strip 30 is accommodated in an inner space or is not accommodated.

The holding portion 200 may be disposed on an upper side of the desk 20, and may hold a terminal 10 when the main body 100 is attached to the lower side of the desk 20, and may be configured to prevent a charging cable 11 connected with the terminal 10 from being disconnected from the power strip 30 accommodated in the inner space of the main body 100 by a movement.

The fixing portion 300 may be provided to grip one side of the desk and the main body 100 to attach the main body 100 to the lower side of the desk 20 and to fix the main body 100, and may be drawn in the holding portion 200 to allow the holding portion 200 to be placed on the upper side of the desk 20, and may be configured to allow the terminal 10 to be safely held on the holding portion 200 when the holding portion is secured.

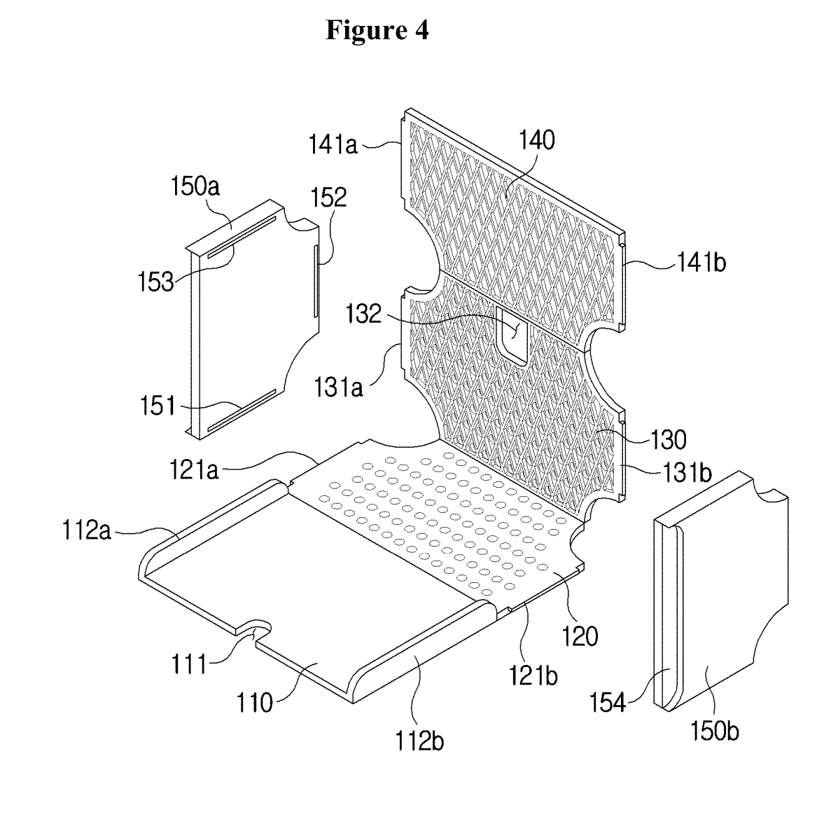

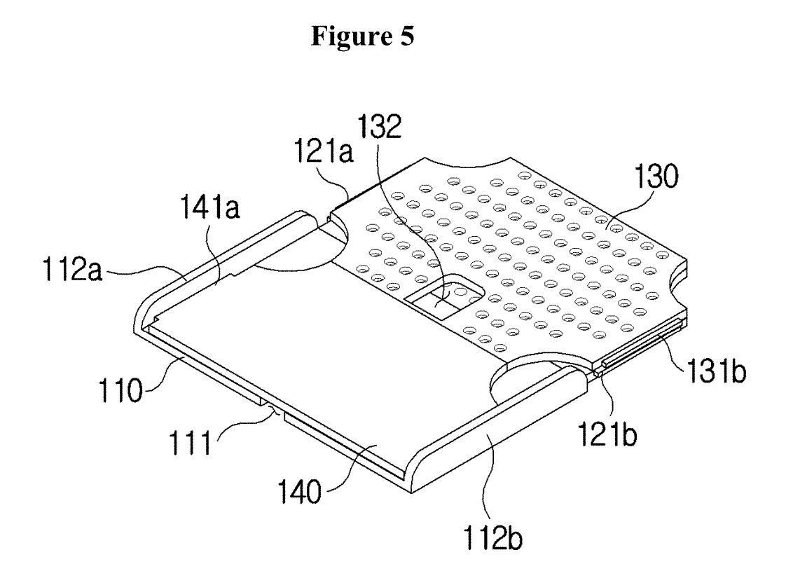

FIG. 4 is a view illustrating the main body in an unfolded position according to an embodiment of the present disclosure, and FIG. 5 is a view illustrating the main body in a folded position according to an embodiment of the present disclosure.

As shown in FIGS. 4 and 5, the main body 100 may be attached to the lower side of the desk 20 spaced from a floor, and may include a front plate 110, a lower plate 120, a rear plate 130, an upper plate 140, and both side plates 150 which are folded to be stored with its volume being reduced when the power strip 30 is accommodated in the inner space or is not accommodated.

The front plate 110 may be opened or closed to allow the power strip 30 to be accommodated in the inner space of the main body 100 or to be drawn out therefrom, and may have a hinge disposed at one side thereof to be unfolded through a rotation, such that the front plate 110 is folded when the power strip 30 is not accommodated. Herein, the hinge may be coupled to one side of the lower plate 120.

In addition, the front plate 110 may have a lead-in recess 111 formed on a width area of the front plate 110 to allow a user's finger to be drawn in therethrough, such that the user can easily put the power strip 30 into the inner space of the main body 100 and draw out the power strip 30 from the main body 100.

In addition, the front plate 110 may include a plurality of wings 112a, 122b protruding from both sides thereof to allow the inner space of the main body 100 to be opened or closed based on the hinge provided at one side of the front plate 110. The plurality of wings 112a, 112b may be attached to or detached from a plurality of wing receiving recesses 154 formed on outer surfaces of the both side plates 150 corresponding to both side surfaces of the main body 100.

More specifically, when the plurality of wings 112a, 112b are received on the plurality of wing receiving recesses 154, the front plate 110 may be closed with the power strip 30 being accommodated in the inner space of the main body 100, and, when the plurality of wings 112a, 112b are detached from the plurality of wing receiving recesses 154, the front plate 110 may be rotated based on the hinge and may be opened to allow the power strip 30 to be drawn out from the inner space of the main body 100.

The lower plate 120 may be configured to allow the power strip 30 to be accommodated in the inner space of the main body 100, and may have one side coupled to the hinge of the front plate 110 to be unfolded through the rotation of the hinge, and may have a hinge disposed at the other side to be coupled to one side of the rear plate 130, such that the lower plate 120 is unfolded and folded when the power strip 30 is not accommodated.

In addition, the lower plate 120 may include protrusions 121a, 121b protruding from both sides thereof to allow the both side plates 150 to be attached thereto or detached therefrom, such that the lower plate 120 is unfolded and folded when the power strip 30 is not accommodated in the inner space of the main body 100.

The rear plate 130 may have one side coupled to the hinge provided on the lower plate 120 to be unfolded through the rotation of the hinge, and may have a hinge disposed at the other side to be coupled to one side of the upper plate 140, such that the rear plate 130 is unfolded and folded when the power strip 30 is not accommodated in the inner space of the main body 100.

In addition, the real plate 130 may have a fixing receiving recess 132 formed on one end of a width area thereof to allow a lower end of the fixing portion 300 supporting a load of the main body 100 to be received in the main body 100 therethrough, such that the main body 100 is attached to the lower side of the desk 20.

In addition, the rear plate 130 may include protrusions 131a, 131b protruding from both sides thereof to allow the both side plates 150 to be attached thereto or detached therefrom, such that the rear plate 130 is unfolded and folded when the power strip 30 is not accommodated in the inner space of the main body 100.

The upper plate 140 is a plate that allows the main body 100 to be attached to the lower side of the desk 20 through the fixing portion 300. The upper plate 140 may have one side coupled to the hinge provided on the rear plate 130 to be unfolded through the rotation of the hinge, such that the upper plate 140 is unfolded and folded when the power strip 30 is not accommodated in the inner space of the main body 100.

In addition, the upper plate 140 may include protrusions 141a, 141b protruding from both sides thereof to allow the both side plates 150 to be attached thereto or detached therefrom, such that the upper plate 140 is unfolded and folded when the power strip 30 is not accommodated in the inner space of the main body 100.

The both side plates 150 may include a left plate 150a and a right plate 150b disposed at both sides of the main body 100 when the main body 100 is in an assembled position, and may be separated from both side surfaces of the main body 100 when the main body 100 is unfolded without the power strip 30 in the inner space of the main body 100.

In this case, the both side plates 150a, 150b may include protrusion receiving recesses 151, 152, 153 formed on inner surfaces of the both side plates 150a, 150b to allow the protrusions protruding from both sides of the lower plate 120, the rear plate 130, and the upper plate 140 to be attached thereto or detached therefrom.

In addition, the right plate 150b in the embodiment of the present disclosure of FIG. 4 may have protrusion receiving recesses 151, 152, 153 formed on inner surface of the right plate 150b, and a wing receiving recess 154 may be formed on the outer surface of the left plate 150a although they are not shown.

In addition, in an embodiment of the present disclosure, the first protrusion receiving recess 151 may be attached to or detached from the main body 100 by being coupled to or decoupled from the protrusions 121a, 121b of the lower plate, the second protrusion receiving recess 152 may be attached to or detached from the main body 100 by being coupled to or decoupled from the protrusions 131a, 131b of the rear plate, and the third protrusion receiving recess 153 may be attached to or detached from the main body 100 by being coupled to or decoupled from the protrusions 141a, 141b of the upper plate.

In addition, if the lower plate 120, the rear plate 130, and the upper plate 140 of the main body 100 are not provided with protrusions and are provided with protrusion receiving recesses 151, 152, 153, a plurality of protrusions may be formed on the inner surfaces of the both side plates 150a, 150b, and the both side plates 150a, 150b may be attached to or detached from the main body 100.

In an embodiment of the present disclosure, the main body 100 may be unfolded and then may be retracted when the power strip 30 is not accommodated in the inner space. To achieve this, when the main body 100 is rotated and folded about the hinge provided between the lower plate 120 and the rear plate 130, the lower plate 120 and the rear plate 130 may be brought into contact with each other, and the front plate 110 and the upper plate 140 may be brought into contact with each other.

In this case, when the main body 100 is unfolded and then is retracted, the protrusions 141a, 141b protruding from both sides of the upper plate 140 may be brought into contact with inner surfaces of the plurality of wings 112a, 112b provided on both sides of the front plate 110, and may be secured thereto, and thus a securing force of the main body 100 in the folded position may be reinforced. To this end, when the main body 100 is unfolded and then is folded, the main body 100 can be prevented from being released by a movement.

In addition, both ends of one side of the rear plate 130, which is coupled to the other side of the lower plate 120, and corners of both ends of the other side of the rear plate 130 and both ends of one side of the upper plate 140 may be recessed, and accordingly, a plurality of recesses may be formed to allow a cable connected with the power strip 30 to be freely received in the main body 100 or to be drawn out therefrom when the main body 100 accommodates the power strip 30 in the inner space thereof while being attached to the lower side of the desk 20. To this end, the cable can be freely received in the main body 100 or drawn out therefrom in a direction from the upper side of the desk 20.

Accordingly, the power strip 30 may be accommodated when the front plate 110 of the main body 100 attached to the lower side of the desk 20 is opened toward the outside, and, after a cable is connected to the accommodated power strip 30, the cable may be drawn out from the inner space through the recess for allowing a plurality of cables to be drawn in or drawn out therethrough, and may be connected to an external device. When the cable is connected to the power strip 30, the front plate 110 may be closed and thus the power strip 30 can be safely stored.

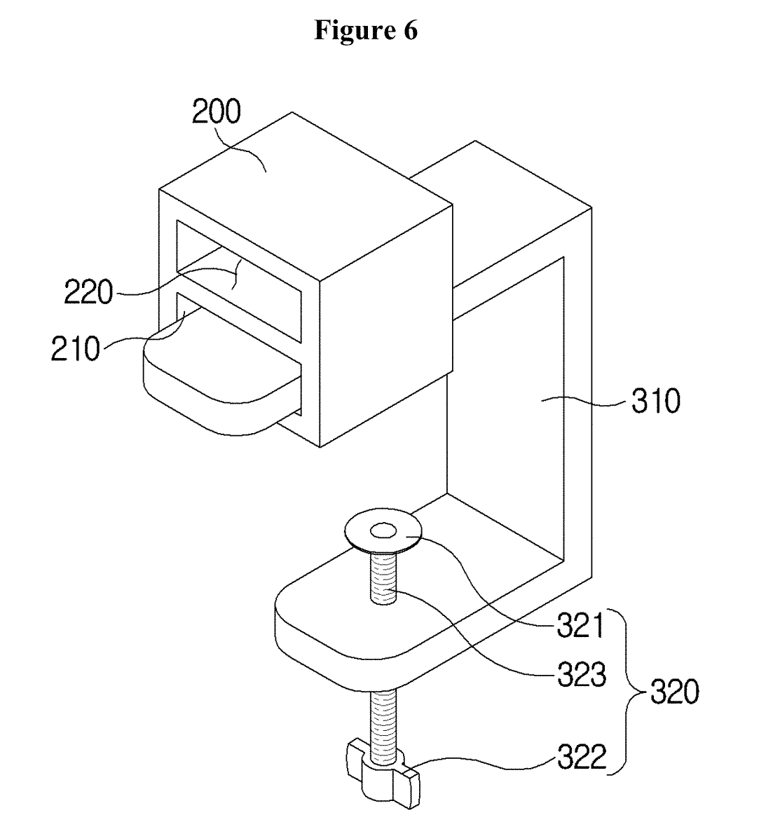

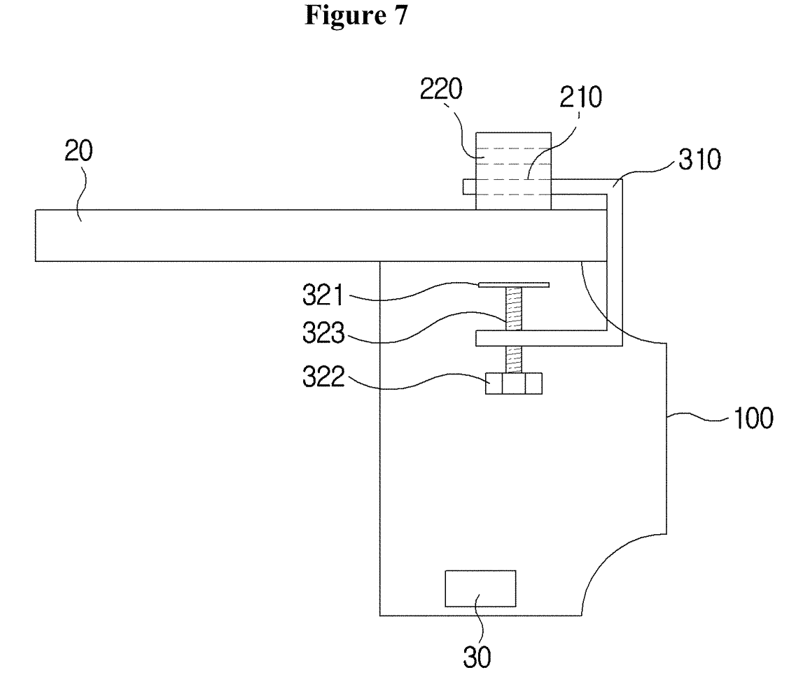

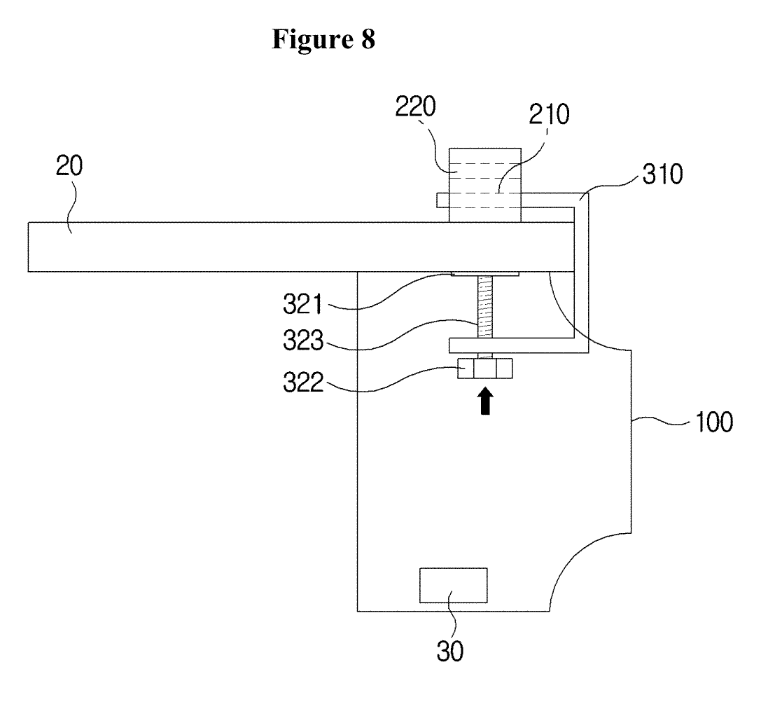

FIG. 6 is a view illustrating the fixing portion and the holding portion which are coupled to each other according to an embodiment of the present disclosure, FIG. 7 is a view illustrating a state before the main body is attached to the lower side of the desk according to an embodiment of the present disclosure, and FIG. 8 is a view illustrating a state in which the main body is attached to the lower side of the desk according to an embodiment of the present disclosure.

As shown in FIGS. 6 to 8, the foldable power strip storage tray may allow the main body 100 to be attached to the lower side of the desk 20, and may include the holding portion 200 and the fixing portion 300 to hold the terminal 10 on the upper side of the desk 20 in a fixed position, and simultaneously, to prevent the charging cable 11 connected with the terminal 10 from being disconnected from the power strip 30 accommodated in the inner space of the main body 100 due to a movement.

The holding portion 200 may be formed in a cuboid shape and disposed on the upper side of the desk 20 to allow one side of the terminal 10 to be held on a curved outer surface thereof and to serve as a strut, and may have a plurality of receiving recesses 210, 220 formed in a direction parallel to a width direction of the table 20 to allow the charging cable 11 and the upper end of the fixing portion 300 to be drawn in or drawn out therethrough.

In addition, one of the plurality of receiving recesses 210, 220 of the holding portion 200 may be formed to have a shape corresponding to the shape of the upper end of the fixing portion 300, which allows the main body 100 to be attached to the lower side of the desk 20, and, when the upper end of the fixing portion 300 is inserted into the one receiving recess as much as an area of a predetermined length, the securing force of the fixing portion 300 can be reinforced in a state in which the fixing portion 300 hangs on one side of the desk.

In the following description, the receiving recess having the shape corresponding to the shape of the upper end of the fixing portion 300 is limited to the receiving recess 210 closer to the upper side of the desk 20 from among the pair of receiving recesses according to an embodiment of the present disclosure.

In addition, the receiving recess 220 may be provided to prevent the charging cable 11 from being disconnected from the power strip 30 due to a movement when the charging cable 11 connected with the terminal 10 passes through the receiving recess 220 and is connected to the power strip 30 accommodated in the inner space of the main body 100 attached to the lower side of the desk 20.

The fixing portion 300 may include a fixing frame 310 and a fixing member 320 to allow the main body 100 to be attached to the lower side of the desk 20.

The fixing frame 310 may have one side opened and have an upper end hanging on one side of the desk in order to place the main body 100 under the desk 20, and may have a lower end drawn in through the fixing receiving recess 132 of the main body 100 to support the load of the main body 100.

The fixing member 320 may include a pressing member 321, a rotation fixing member 322, and a shaft member 323 to securely support the load of the main body 100 when the lower end of the fixing frame 310 is drawn in the main body 100.

The pressing member 321 may be disposed on an upper side of the shaft member 323 in the form of a plate to bring the main body 100 into close contact with the lower side of the desk 20, and may press the upper plate 140 of the main body 100 toward the desk 20 to bring the upper plate 140 into close contact with the lower side of the desk 20.

The rotation fixing member 322 may be disposed on a lower side of the shaft member 323 to mount or dismount the main body 100 on or from the lower side of the desk 20, and, when the rotation fixing member 322 is rotated in one direction, the pressing member 321 may move upwardly and bring the main body 100 into close contact with the desk 20, and, when the rotation fixing member 322 is rotated in the opposite direction of one direction, the pressing member 321 may move downwardly to allow the main body 100 to be spaced from the desk 200.

The shaft member 323 may allow the pressing member 321 to move upwardly or downwardly according to a rotation direction of the rotation fixing member 322, such that the main body 100 is brought into close contact with the desk 20 or is spaced from the desk 20.

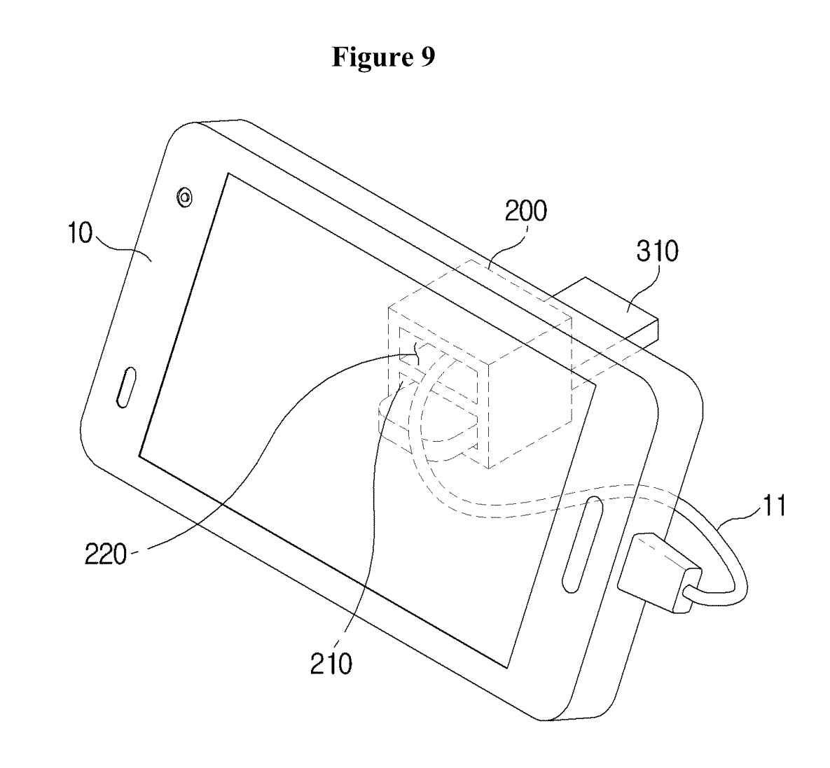

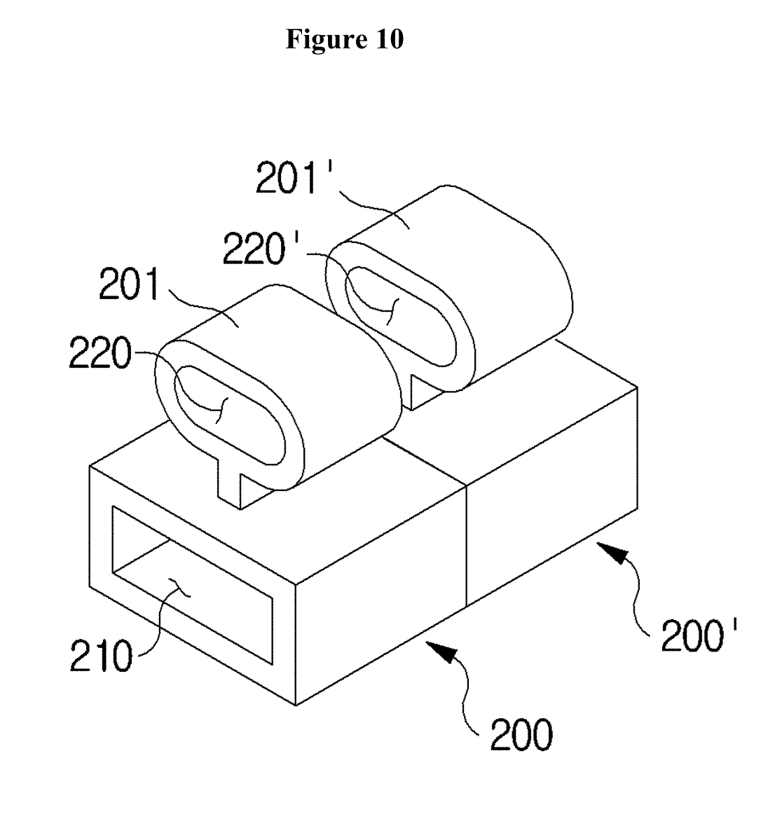

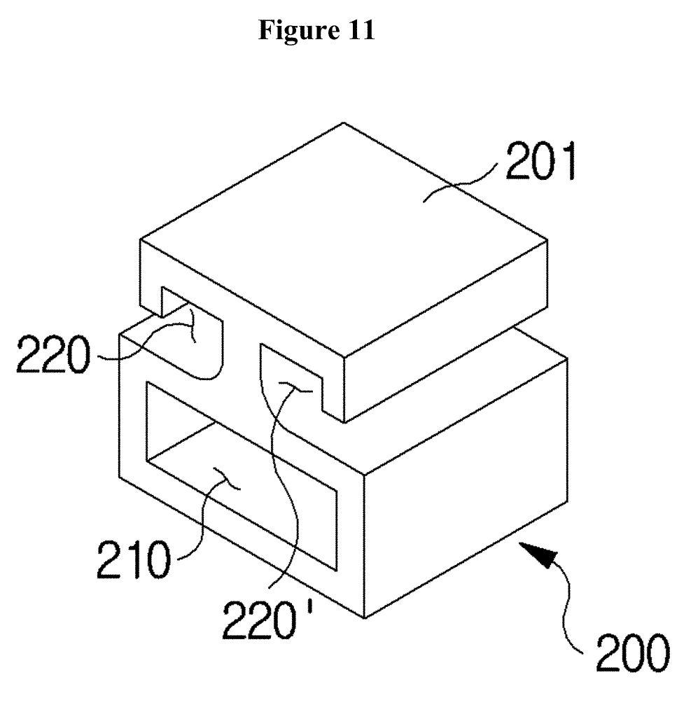

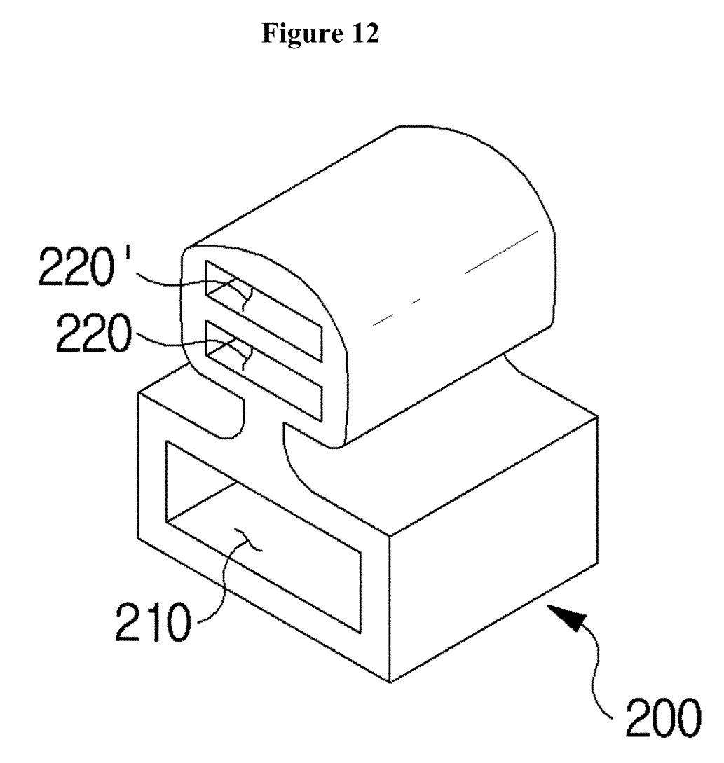

FIG. 9 is a view illustrating a using example of the holding portion according to an embodiment of the present disclosure, FIG. 10 is a view illustrating a holding portion according to another embodiment of the present disclosure, FIG. 11 is a view illustrating a holding portion according to still another embodiment of the present disclosure, and FIG. 12 is a view illustrating a holding portion according to yet another embodiment of the present disclosure.

As shown in FIGS. 9 to 12, the holding portion 200 may be configured to maintain the terminal in a held position even when there occurs a movement in the charging cable connected to the terminal.

According to another embodiment shown in FIG. 10, the holding portion 200 may include a first holding portion 200 and a second holding portion 200′ to allow an area of a predetermined length of the upper end of the fixing portion 300 to be received therein or drawn out therefrom, and to prevent the charging cable 11 connected to the terminal 10 from being disconnected from the power strip 30 accommodated in the inner space of the main body 100 when the charging cable 11 is received in the holding portion.

More specifically, the holding portions 200, 200′ may have receiving recesses 210, 210′ formed therein to allow the upper end of the fixing portion 300 to be received therein or to be drawn out therefrom, and may have receiving recesses 220, 220′ formed therein to allow the charging cable 11 to be received therein or to be drawn out therefrom.

In addition, upper sides 201 of the holding portion having the receiving recesses 220, 200′ formed therein may be formed of silicon or rubber, such that the charging cable 10 can be easily prevented from being moved while being received in the receiving recesses 220, 220′, and also, can be prevented from being damaged when a user uses the terminal 10.

In addition, the upper sides 201 of the holding portion may be formed to be smaller than the holding portions 220, 220′, such that the user can easily use the terminal 10 in a held position when the terminal 10 is held on the holding portions 200, 200′.

In addition, the holding portion includes one or more holding portions 200, 200′ and thus a larger area of a predetermined length of the charging cable 11 connected to the terminal 10 is received in the holding portions, such that the charging cable 11 can be further prevented from being damaged by a movement of the terminal 10, and, since the holding portion is disposed on the upper side of the desk 20 to occupy a longer area, the securing force of the fixing portion 300 hanging on one side of the desk 20 can be reinforced.

According to still another embodiment shown in FIG. 11, the holding portion 200 may be provided to allow an area of a predetermined length of the upper end of the fixing portion 300 to be received therein or to be drawn out therefrom, and to allow the charging cable 11 connected to the terminal 10 to be received therein or to be wound around a shaft, and thus to prevent the charging cable 11 from being disconnected from the power strip 30 accommodated in the inner space of the main body 100.

More specifically, the holding portion 200 may have a receiving recess 210 formed therein to allow the upper end of the fixing portion 300 to be received therein or to be drawn out therefrom, and may have receiving recesses 220, 220′ formed under an upper side 201 thereof, formed of silicon or rubber, to allow the charging cable 11 connected to the terminal 10 to be received therein or to be drawn out therefrom.

In this case, the charging cable 11 may be wound around the shaft formed on the center of the upper side 201 of the holding portion and connected to the holding portion 200, and then may be connected to the terminal 10 for use, such that the charging cable 11 can be prevented from being released from the insides of the receiving recesses 220, 200′ due to a movement.

In addition, the upper side 201 of the holding portion may be formed of silicon or rubber, such that both ends of the upper side 201 of the holding portion are bendable by an external force, and thus the user can wind the charging cable 11 around the shaft.

In addition, both ends of the upper side 201 of the holding portion protrude in a perpendicular direction to the floor, such that the charging cable 11 can be received without being wound around shaft, and simultaneously, the receiving recesses 220, 220′ can be defined.

According to yet another embodiment shown in FIG. 12, the holding portion 200 may be provided to allow an area of a predetermined length of the upper end of the fixing portion 300 to be received therein or to be drawn out therefrom, and also, may be provided to prevent a plurality of charging cables 11, which are connected to a plurality of terminals 10, from being disconnected from the power strip 30 accommodated in the inner space of the main body 100 when the charging cables 11 are draws in the holding portion 200.

More specifically, the holding portion 200 may have a receiving recess 210 formed therein to allow the upper end of the fixing portion 300 to be drawn in or drawn out, and may have a plurality of receiving recesses 220, 220′ formed on the upper side of the holding portion 200 to allow the plurality of charging cables 11 to be received therein or drawn out therefrom.

Accordingly, the fixing portion 300 may be fixed, while hanging on one side of the desk 20, with the holding portion 200 being placed on the upper side of the desk 20, and the plurality of charging cables 11 connected to the plurality of terminals 10 are received in the holding portion 200, and ends of the plurality of charging cables 11 can be prevented from being disconnected from the power strip 30 due to a movement.

In addition, the receiving recesses 220, 220′ may be formed to allow the plurality of charging cables 11 to be drawn in, such that the user can easily use the plurality of terminals 10 in a charging state.

Although FIG. 12 depicts that two receiving recesses 220, 220′ are formed on the holding portion 200 to allow the charging cable 11 to be received therein or to be drawn out therefrom, more receiving recesses may be formed to allow more charging cables 11 to be received therein or to be drawn out therefrom.

Accordingly, since the power strip is accommodated in the inner space of the power strip storage tray attached to one side of the desk, problems that the power strip or electric cables are stepped on by a foot and thus are damaged, power supply to electric devices is suddenly stopped, or a moving line of a cleaner is hindered when the floor is cleaned can be solved.

In addition, when the power strip is not accommodated in the inner space of the power strip storage tray, the tray is unfolded and then is folded, and is stored with its volume being minimized, and thus there is a space saving effect.

In addition, the charging cable connected with the terminal can be prevented from being released by a movement, and there is an effect of holding the terminal on the upper side of the desk.

While preferred embodiments of the present disclosure have been shown and described, it will be understood by those skilled in the art that the present disclosure is not limited to the above-described specific embodiments, and various changes in form and details may be made therein without departing from the spirit and scope of the invention as defined by the appended claims. In addition, the changed embodiments should not be interpreted as being separate from the technical idea or scope of the present disclosure.

1. A foldable power strip storage tray comprising:
a main body provided with an inner space to accommodate a power strip;
a fixing portion having one side opened and having an upper end configured to hang on one side of a desk, and configured to support a load of the main body and simultaneously to fix the main body to a lower side of the desk when a lower end of the fixing portion is received in the main body; and
a holding portion configured to contact an upper surface of the desk, and configured to inhibit the fixing portion from sliding from one side of the desk or from being released by a movement when an area of a predetermined length of an upper end of the fixing portion is drawn into the holding portion.

2. The foldable power strip storage tray of claim 1, wherein the main body comprises:
a front plate having a hinge disposed at one side thereof to be opened and closed forward and backward to allow the power strip to be accommodated in the inner space or to be drawn out therefrom, the front plate being provided with a plurality of wings protruding from both sides thereof extending in a perpendicular direction to the one side;
a lower plate having one side coupled to the hinge of the front plate and having a hinge disposed at the other side to allow the power strip to be accommodated in the inner space after the front plate is opened;
a rear plate having a fixing receiving recess formed in a direction to allow a lower end of the fixing portion to be drawn in therethrough, and to allow the fixing portion to support the load of the main body, the rear plate having one side coupled to the hinge of the lower plate and having a hinge disposed at the other side;
an upper plate having one side coupled to the hinge disposed at the other side of the rear plate; and
a left plate and a right plate having a plurality of wing receiving recesses formed on outer surfaces thereof to correspond to a shape of the plurality of wings to allow the front plate to be opened and closed based on the wings, inner surfaces of the left plate and the right plate being coupled to both sides of the lower plate, both sides of the rear plate, and both sides of the upper plate.

3. The foldable power strip storage tray of claim 2, wherein both ends of one side of the rear plate and both ends of the other side of the lower plate, and both ends of the other side of the rear plate and both ends of one side of the upper plate are formed to have recessed corners to allow an end of one or more charging cables connected to the power strip to be accommodated in the inner space, and, when the main body is assembled, a plurality of cable receiving recesses are formed to receive the plurality of charging cables.

4. The foldable power strip storage tray of claim 2, wherein the main body comprises protrusions formed on both sides of the lower plate, both sides of the rear plate, and both sides of the upper plate to allow the left plate and the right plate to be attached to or detached from the other portions of the main body, and protrusion receiving recesses are formed on the inner surfaces of the left plate and the right plates to receive the protrusions.

5. The foldable power strip storage tray of claim 4, wherein, when the left plate and the right plate of the main body are detached based on the protrusions and then the other portions of the main body are unfolded, the main body portion is folded with reference to the hinge disposed on the lower plate and then is folded in such a manner that the lower plate and the rear plate are brought into contact with each other and the upper plate and the front plate are brought into contact with each other.

6. The foldable power strip storage tray of claim 5, wherein, after the main body portion is folded, inner surfaces of the wings formed on the front plate and the protrusions formed on the upper plate are brought into contact with each other, and the upper plate is fitted into the front plate, such that the main body is inhibited from being released by a movement.

7. The foldable power strip storage tray of claim 1, wherein the fixing portion comprises:
a fixing frame having one side opened to allow an upper side of the main body and one side of the desk to be drawn in therethrough;
a pressing member configured to press the upper side of the main body to stably fix the main body to a lower surface of the desk;
a shaft member formed on a lower side of the pressing member to allow the pressing member to press the main body or to be spaced from the main body, and configured to move the pressing member upwardly and downwardly by being rotated through the lower end of the fixing frame in a perpendicular direction to a floor; and
a rotation adjustment member formed on a lower side of the shaft member to move the pressing member upwardly and downwardly by a predetermined height in the perpendicular direction to the floor through the shaft member.

8. The foldable power strip storage tray of claim 1, wherein the holding portion comprises one or more receiving recesses to hold a terminal on one side after the upper end of the fixing portion is drawn in, the holding portion being configured to maintain the terminal in a held position even when a charging cable connected to the terminal moves, and one receiving recess is configured to receive the upper end of the fixing portion, and the other receiving recess is configured to receive the charging cable.

9. The foldable power strip storage tray of claim 8, wherein the receiving recess of the one or more receiving recesses of the holding portion that has the fixing portion received therein has a shape corresponding to that of the upper end of the fixing portion, such that the holding portion is inhibited from being released by a movement after the upper end of the fixing portion is drawn therein.
